(19) United States
(12) Patent Application Publication
(10) Pub. No.: US 2024/0103214 A1
(43) Pub. Date: Mar. 28, 2024

(54) THERMALLY ANNEALED GRATINGS IN COATED FIBER AND RELATED SYSTEMS AND METHODS

(71) Applicant: OFS Fitel, LLC, Norcross, GA (US)

(72) Inventors: Robert S Dyer, East Granby, CT (US); Adam Hokansson, Granby, CT (US); Matthew Popelka, Canton, CT (US); Brian Savran, Canton, CT (US); Paul S Westbrook, Basking Ridge, NJ (US); Vixay R Soundara, East Hartford, CT (US); Andrei A Stolov, Simsbury, CT (US)

(73) Assignee: OFS Fitel, LLC, Norcross, GA (US)

(21) Appl. No.: 18/275,247

(22) PCT Filed: Feb. 2, 2022
(86) PCT No.: PCT/US22/14982

§ 371 Date: Aug. 1, 2023

Related U.S. Application Data
(60) Provisional application No. 63/144,598, filed on Feb. 2, 2021.

(51) Int. Cl. G02B 6/02; C03B 37/10; C03C 13/04; C03C 25/106

(52) U.S. Cl. CPC G02B 6/02104; C03B 37/10; C03C 13/04; C03C 25/106; G02B 6/02123; C03C 2213/00; G02B 2006/02161

(57) ABSTRACT

Described herein are systems, methods, and articles of manufacture for a coated fiber modified by actinic radiation to increase back-scattering, which experiences very little back-scattering decay at a temperature and time of exposure that is sufficient to noticeably degrade the coating and/or noticeably degrade the optical fiber due to outgassing of hydrogen from the coating. In one embodiment, an optical fiber comprises a fiber length, a coating having a treated coating weight, wherein the treated coating weight is at least 25% less of an original coating weight prior to an annealing treatment, and an optical back-scatter along the fiber length greater than a Rayleigh back-scattering over the fiber length, wherein the optical back-scatter does not decrease along the fiber length by more than 3 dB after exposure to annealing treatment. A further embodiment relates to a method comprising receiving an optical fiber at an inlet of at least one heat source, the optical fiber including a coating having an original coating weight and an optical back-scatter along a fiber length and applying an annealing treatment to the optical fiber by the least one heat source at a predetermined temperature Tₐ during a predetermined time tₐ, wherein the original coating weight is reduced by at least 25% to a treated coating weight during the annealing treatment, wherein the optical back-scatter does not decrease along the fiber length by more than 3 dB after the annealing treatment.

### CROSS-REFERENCE TO RELATED APPLICATIONS

This application claims the benefit of U.S. Provisional Application No. 63/144,598, filed Feb. 2, 2021, and herein incorporated by reference.

### TECHNICAL FIELD

Described herein are systems, methods, and articles of manufacture for a coated fiber modified by actinic radiation to increase back-scattering.

### BACKGROUND OF THE INVENTION

It is known that actinic radiation of various types, e.g., UV radiation, or femtosecond IR radiation may be used to modify the refractive index of an optical fiber and thereby increase the back-scattering in the optical fiber, or even inscribe one or more quasi-periodic fiber gratings along the light-guiding core of the fiber. It is known that such modifications of the index of optical fibers can decay in strength over time, thereby reducing reflected power.

In order to stabilize the index perturbations giving rise to the enhanced back-scattering or Bragg grating reflection, such gratings are often subjected to a stabilizing anneal at a temperature in excess of the temperature at which they will operate in their application. These high temperatures are typically beyond the acceptable temperatures of the protective coating that surrounds the glass portion of the fiber. For instance, a typical germanosilicate optical fiber grating would be annealed at a temperature of 150° C. for two days to stabilize the fiber grating reflectivity for operation at temperatures below 80° C. for many years. However, the typical dual acrylate coating that surrounds the fiber would degrade substantially after exposure to 150° C. for two days, and thereby limit the usefulness of the fiber grating written into the fiber. It is possible to decrease the anneal temperature to one that is compatible with the dual acrylate coating, typically below 100° C. However, such an anneal must be done over very long times to ensure minimal decay of the grating reflectivity over a period of time at 80° C.

Therefore, there is a need for a method of stabilizing actinic modifications of the refractive index of an optical fiber in a relatively short time and without degrading the optical coating.

### SUMMARY OF THE INVENTION

The present invention addresses the needs in the art and is directed to a coated fiber modified by actinic radiation to increase back-scattering, which experiences very little back-scattering decay at a temperature and time of exposure that is sufficient to noticeably degrade the coating and/or noticeably degrade the optical fiber due to outgassing of hydrogen from the coating.

An exemplary embodiment of the present invention takes the form of an article of manufacture configured to provide an optical fiber comprising a fiber length, a coating having a treated coating weight, wherein the treated coating weight is at least 25% less of an original coating weight prior to an annealing treatment, and an optical back-scatter along the fiber length greater than a Rayleigh back-scattering over the fiber length, wherein the optical back-scatter does not decrease along the fiber length by more than 3 dB after exposure to annealing treatment.

A further exemplary embodiment of the present invention takes the form of a method configured to thermally stabilize a fiber grating without removing or degrading the fiber coating and which allows for the release of hydrogen. More specifically, such a method comprises receiving an optical fiber at an inlet of at least one heat source, the optical fiber including a coating having an original coating weight and an optical back-scatter along a fiber length and applying an annealing treatment to the optical fiber by the least one heat source at a predetermined temperature Tₐ during a predetermined time tₐ, wherein the original coating weight is reduced by at least 25% to a treated coating weight during the annealing treatment, wherein the optical back-scatter does not decrease along the fiber length by more than 3 dB after the annealing treatment.

Other and further embodiments and aspects of the present invention will become apparent during the course of the following discussion and by reference to the accompanying drawings.

### BRIEF DESCRIPTION OF THE DRAWINGS

Referring now to the drawings:

FIG. 1 is a graph showing exemplary anneal conditions including the values of time and temperature for which the coating survives in accordance with one embodiment of the present invention;

FIG. 2 shows an exemplary system for fiber annealing where the fiber moves through a furnace and returns to a hardened non-sticky state after leaving the furnace in accordance with one embodiment of the present invention;

FIG. 3 shows an exemplary system to introduce index perturbations with an actinic beam, anneal the actinic index perturbations and restore the coating to a hardened and non-sticky state in accordance with one embodiment of the present invention;

FIG. 4 shows an exemplary system for introducing actinic radiation for index perturbations, applying a coating, annealing the fiber, and allowing the fiber to cool and reharden after the anneal in accordance with one embodiment of the present invention;

FIG. 5 shows an exemplary system with more than one furnace or heat source, each with its own temperature, in accordance with one embodiment of the present invention; and

FIGS. 6A-6C show various coating images with their corresponding degradation.

### DETAILED DESCRIPTION

As will be discussed in detail below, the present invention relates to exemplary embodiments described herein relate to a coated fiber modified by actinic radiation to increase back-scattering, which experiences very little back-scattering decay at a temperature and time of exposure that is sufficient to noticeably degrade the coating and/or noticeably degrade the optical fiber due to outgassing of hydrogen from the coating. Further described herein is a method of thermally stabilizing a fiber grating without removing or degrading the fiber coating and which allows for the release of hydrogen.

The exemplary embodiments described herein address the limitations discussed above by performing a stabilization anneal in a regime of time and temperature that will allow the coating to survive. There are several factors that characterize the fiber degradation at elevated temperatures. One of the factors is the thermal and thermooxidative degradation of the coating, which leads to the coating radial and axial shrinkage and alterations in the coating's mechanical properties. In addition, the coating shrinkage develops mechanical stress on the fiber which leads to micro bends and added optical loss. Secondly, if the fiber is wound on a spool with adjacent coils touching each other, then at elevated temperatures the diffusion of the unreacted coating components may lead to adhesion of the adjacent fiber strands. The adhesion, in its turn, may result in difficulties when further uncoiling the fiber, including potential fiber breaks. Still, another failure mode is related to the coating degradation products that may include molecular hydrogen. The evolved hydrogen might diffuse into the fiber cladding and the core, which is known to cause an added optical loss. The hydrogen ingression in the fiber will be much stronger if the fiber is tightly spooled, which hinders the release of the evolved hydrogen into the atmosphere and traps it within the spool.

One exemplary embodiment of the invention pertains to annealing of the fiber in a “reel-to-reel” format, while it passes through a space with an elevated temperature, such as a thermal oven or furnace. Each section of the fiber is exposed to a very high temperature, but for a short period of time. After passing through the hot area, the fiber is cooled down to room temperature before getting to the takeup spool—this way, the stickiness of the adjacent fiber coils is substantially prevented. Next, once the piece of the fiber being annealed is isolated from the rest of the spooled fiber, the evolved hydrogen is released primarily into the surrounding atmosphere and much less being ingressed in the fiber.

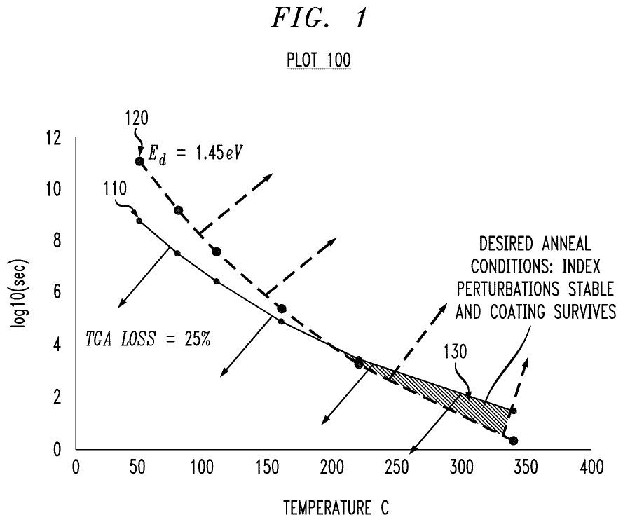

As mentioned above, exposing the fiber to high temperatures leads to the coating's thermal degradation. As stated above, the coating degradation may be characterized by different parameters. For simplicity, a single property of the coating may be considered. However, the analysis described herein may be applied to any of the coating quality parameters. For example, the coating degradation may be characterized using thermogravimetric analysis, or “TGA.” The coating sample is heated to various temperatures and the mass of the sample is recorded. The coating lifetime is then characterized by the amount of weight loss. For instance, a typical criterion for lifetime t_{life} at a given temperature Tₘₐₓ would be a 25% weight loss. For low temperatures, the lifetime can be exponentially longer than at higher temperatures. For instance, for a given acrylate-based fiber coating the set of values t_{life} and Tₘₐₓ that give 25% weight loss would be those shown by the blue (solid) lines and arrows in the plot 100 of FIG. 1. On this plot, therefore, the coating will survive for all t_{life} and Tₘₐₓ below the blue (solid) line 110.

As depicted in the plot 100 of FIG. 1, the blue (solid) line 110 and arrows indicate values of time and temperature for which the coating survives. The orange (dashed) line 120 and arrows indicate the time and temperatures for which the index perturbations are stable. The green (shaded) region 130 is the desired stabilization anneal region for which the coating survives and the index perturbations have been thermally stabilized.

On the other hand, the required annealing time tₐ and annealing temperature Tₐ for the grating to be stable at a lower temperature can be characterized by a demarcation energy:

E_{d}=k_{B}Tₐln(υ₀tₐ) [Eq. 1]

Where k_{B} is the Boltzmann constant and υ₀ is a frequency characteristic of the particular system. According to Eq. 1, any values of tₐ and Tₐ that give the desired value of E_{d} will ensure the desired stability of the index perturbations at the lower operating temperature. This means that the decay of the back-scattering of the core guided light into backward propagating, core guided light, arising from the index perturbations will be limited to a desired decrease, for instance at most 3 dB. Note that other means of relating the dependence of grating decay on time and temperature, such as stretched-exponential or even fully experimental curves may be used. Note that it may be acceptable for the index perturbations to diminish at a lower temperature during use, so absolute stability is not necessarily required. However, a certain value of E_{d} will ensure that any further decline in the index perturbations is kept to an acceptable value.

The set of tₐ and Tₐ for a demarcation energy of 1.45 eV and a value of υ₀=1011.5 Hz is shown by the orange (dashed) line in plot 100 of FIG. 1. To ensure the stability of the index perturbations and the back-scattering, the values of tₐ and Tₐ should be above this orange (dashed) line 120. The green (shaded) area 130 is then the desired regime for the stabilization anneal since it is below the blue (solid) line 110 and above the orange (dashed) line 120. Therefore, for instance, an anneal at 300° C. for 100 seconds would stabilize the grating while still leaving the coating intact.

It is noted that the operating temperature may be much lower. For instance, the requirement may be that the temperature is 100° C. for 10⁶ seconds. In this example, both the coating and index perturbations would then survive. One notable aspect of the invention is the relative interplay between coating degradation and annealing, so while plot 100 of FIG. 1 shows a particular description of coating degradation and demarcation map, other parameters that characterize coating degradation or annealing of defects resulting from exposure to actinic radiation may be used based on details and requirements such as fiber application of use, composition, design and the like.

It is noted that the exemplary embodiments will be detectable in a given fiber with index perturbations. This fiber would be placed in an oven for a set time and the coating and fiber degradation would be noted. The measurement would be repeated for higher temperatures. Exemplary embodiments of the invention would be evident when, for a given temperature, the coating would show failure, while the index perturbations would still be stable. For instance, the coating would show TGA weight loss greater than 25% while the back-scatter from the index perturbations would decrease by less than 3 dB. For instance, if the fiber annealed at 300° C. for 100 seconds was placed at 150° C. for 10⁵⁵ seconds, then the coating would fail since this point is above the blue (solid) line 110 in FIG. 1. On the other hand, the index perturbations would remain stable since this point is below the orange (dashed) line 120.

It is further noted note that if the anneal is performed at a very high temperature it may be performed over only a very short time. Therefore, the fiber may be annealed in a vessel that allows for the removal of any unwanted outgas sing from the coating or fiber. In particular, if the coating outgasses hydrogen during the anneal, the hydrogen may be removed from the vicinity of the fiber by flowing another gas or gas mixture past the fiber. Moreover, the annealing time may be sufficiently short that any hydrogen that evolves from the coating has insufficient time to penetrate the glass fiber and react with the core material used to guide light in the fiber. Note that the diffusion coefficient and saturation level of hydrogen in silica and the rate of reaction of hydrogen with the core are temperature dependent and thus may be controlled by changing the local fiber temperature after the annealing step.

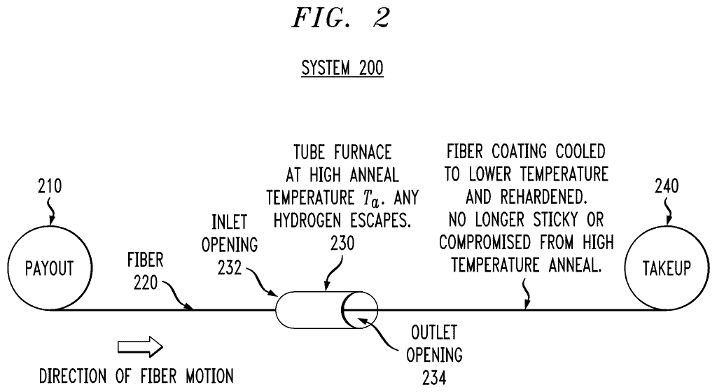

In yet another embodiment, such as the system 200 depicted in FIG. 2, the fiber 220 is annealed at an anneal temperature inside a furnace 230 that is not enclosed. According to the embodiment of system 200 in FIG. 2, the fiber 220 moves through a furnace 230 and returns to a hardened non-sticky state after leaving the furnace 230. Any hydrogen or other volatiles evolved from the fiber 220 are released at the inlet 232 and outlet 234 of the furnace 230 or soon after the fiber 220 leaves the furnace 230 and before the fiber 220 is spooled only by the takeup 240. Accordingly, the fiber 220 may be spooled from the payout spool 210 into the tube furnace 230 and then from the outlet 234 of the tube furnace 230 onto a takeup spool 240. In this embodiment, any hydrogen that outgasses from the fiber 220 is released in the furnace 230 or soon after the fiber 220 leaves the furnace 230, and escapes from the inlet 232 and/or outlet 234 opening of the furnace 230.

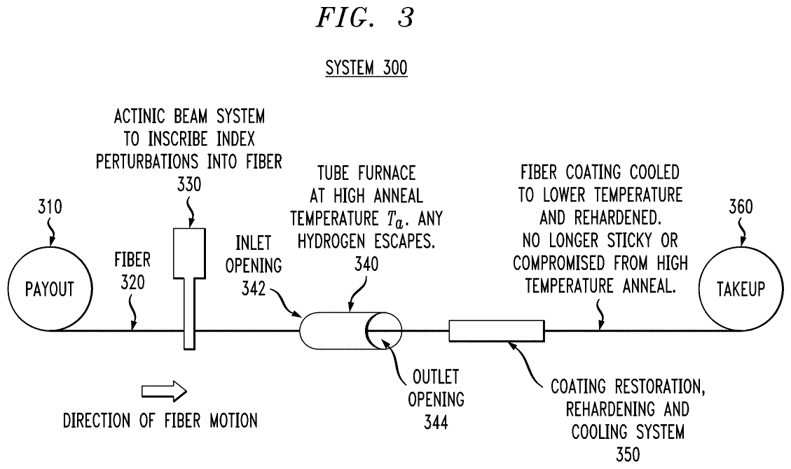

FIG. 3 depicts an alternative system 300 to introduce index perturbations with an actinic beam, anneal the actinic index perturbations and restore the coating to a hardened and non-sticky state. As shown in FIG. 3, the index perturbations may be introduced in the system 300 in the section of the fiber 320 from a payout spool 310 before the furnace 340 (e.g., inlet opening 342). Moreover, the region after the furnace 340 (e.g., outlet opening 344) may have a system 350 to reharden and restore the coating before takeup spool 360. Such a system 350 may simply be cooling through exposure to ambient air. However, it might also be a UV curing lamp, a second lower temperature furnace, a fiber cooling device, or a system to flow restorative gasses on the fiber coating. The purpose of this system 350 would be to reharden and restore the coating to a quality that is within the specifications required by the application that has been designated for the fiber 320.

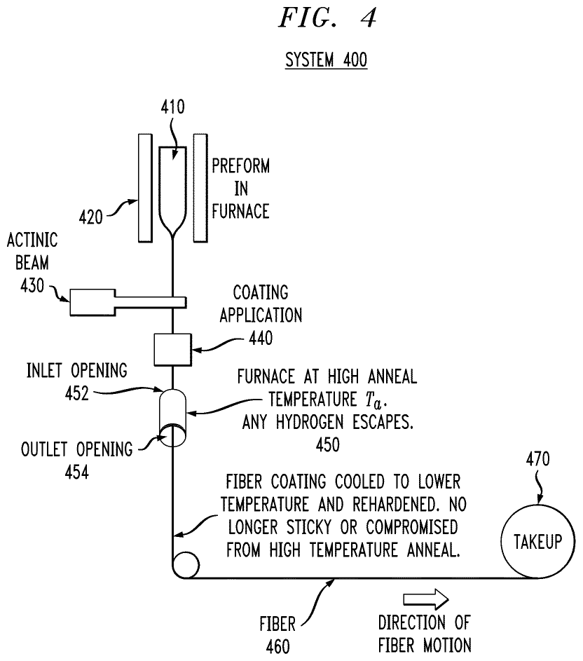

In another embodiment, such as the system 400 depicted in FIG. 4, the annealing is performed directly on a draw tower during the fiber fabrications as fiber 460 is drawn from the preform 410 in the preform furnace 420. System 400 allows for introducing actinic radiation for index perturbations to a fiber 460, applying a coating to the fiber 460, annealing the fiber 460, and allowing the fiber 460 to cool and reharden after the anneal as the fiber 460 travels to the takeup spool 470. Specifically, the exemplary system 400 would have an actinic beam system 430 to introduce index perturbations, a coating system 440 to apply a coating, and an annealing furnace 450 (having an inlet opening 452) to allow for annealing. After outlet opening 454 of the furnace 450, the fiber 460 would be allowed to come to a lower temperature and reharden so that it is no longer sticky or compromised by the high temperature anneal. It is noted that although FIG. 4 shows that the annealing furnace is 450 after the coating application, it is also possible for the furnace 450 to be before the coating application system 440.

In the embodiment of system 400 in FIG. 4, it is possible that the heat source also cures the coating material on the fiber 460. For instance, some acrylate coatings require UV exposure to fully cure. The coating and fiber 460 may increase in temperature during this curing process. It may then be possible to adjust the power of the UV irradiation in such a curing lamp so that the coating is fully cured and the index perturbations are stabilized.

In another example, the coating may require thermal curing. For instance, polyimides often require thermal curing. Such a process can also be adjusted so that the polyimide cures fully and the index perturbations are thermally stabilized. The exemplary embodiments of the invention described herein may be applied with many different types of fiber coatings. These include acrylates, silicones, polyimides, carbon, ceramics, metals, and any combination of these. Any of these materials might be transparent at the wavelength of the actinic radiation. It is noted that the furnace could be any heat source or a plurality of heat sources operating at either the same or different temperatures. For instance, it could be one or more conventional ovens, microwaves, laser energy sources, and/or any combination thereof.

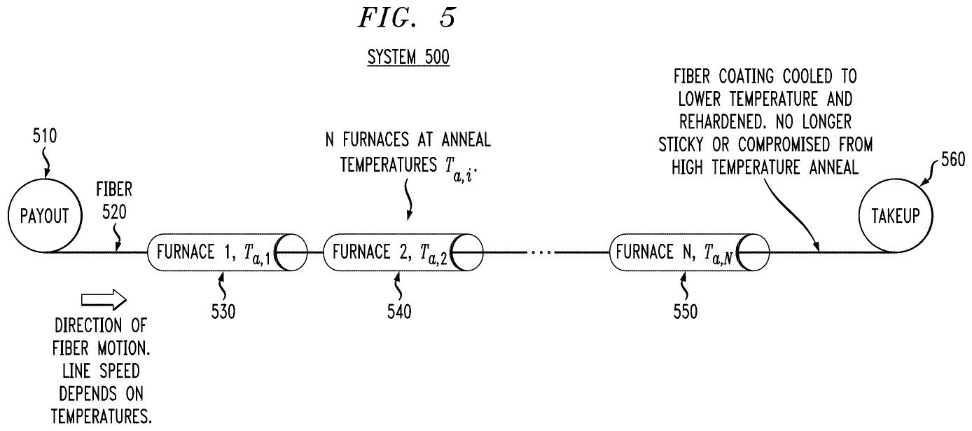

FIG. 5 depicts an additional embodiment of a system 500 with more than one furnace or heat source (e.g., furnaces 530, 540, 550), each with its own temperature. Line speed refers to the rate at which the fiber 520 moves from the payout spool 510 through the furnaces (530, 540, 550) to the takeup spool 560. The furnaces (530, 540, 550) are open at both ends and may be purged with a gas such as nitrogen, argon, or helium.

In another embodiment, a fiber with index perturbations from actinic exposure is annealed while passing through a series of thermal furnaces (530, 540, 550), as shown in FIG. 5. Capabilities of this approach were tested using a fiber that was drawn with a coating similar to the one described in the following patent: “UV-curable silsesquioxane-containing write-through optical fiber coatings for the fabrication of optical fiber Bragg gratings, and fibers made therefrom,” Application No. 15/326,525, filed on Jul. 28, 2015, and issued as U.S. Pat. No. 10,655,034, is incorporated herein by reference.

In the first example, the index perturbations were inscribed in the fiber such that the back-scattering for core guided modes was 25.88 dB larger than Rayleigh scattering, measured right after the actinic exposure. This back-scattering measurement was performed using optical frequency-time domain reflectometry (OFDR) using a commercial OBR OFDR measurement system. This increase in core mode back reflection may also be referred to as the enhancement of the back-scattering over Rayleigh scattering, or equivalently the reflectivity enhancement. Actinic exposure for this example was a pulsed 248 nm excimer laser. The annealing setup used seven 65 cm-long thermal furnaces purged with nitrogen. The temperatures T_{a,1}-T_{a,7} were set to 350° C. and the line speeds trialed for the annealing were 5, 10, 20 and 40 m/min. At all the line speeds, the thermal exposure did not cause significant damage to the coating, while the 1550 nm reflectivity enhancement was found to decrease down to the magnitudes of 21.87, 23.15, 23.61 and 25.84 dB for the line speeds of 5, 10, 20 and 40 m/min, respectively. The line speed is the rate at which the fiber moves through the furnaces.

In the second example, a fiber was drawn with the same coating and the FBGs were inscribed with an enhanced reflectivity of 26.26 dB. The fiber with inscribed FBGs was annealed using the system 500 shown in FIG. 5 with seven nitrogen-purged thermal furnaces set to 450° C. The line speeds used for the annealing were 7.5, 10, 15 and 20 m/min. At these conditions, the thermal exposure did not cause significant damage to the coating, while the reflectivity enhancements measured after the annealing were 15.66, 16.34, 18.47 and 20.37 dB, respectively.

In the third example, a fiber was drawn with the same coating, and the index perturbations gave an enhanced reflectivity of 27.24 dB. The fiber was annealed similarly as described in the previous example at temperatures T_{a,1}-T_{a,7} set to 450° C. and the line speed of 10 m/min. The reflectivity enhancement observed after the anneal was 16.30 dB. The annealed was then subjected to a high-temperature anneal in a thermal furnace in air at 160° C. for 89 hours. A length of fiber with the same actinic exposure and reflectivity enhancement and that had not been annealed in the system 500 of FIG. 5 was subjected to the same annealing conditions. After this anneal, the reflectivity enhancement was found to be 15.92 and 17.81 dB for the annealed and unannealed fibers, respectively. The absence of significant reflectivity decay observed after the aging of the annealed fiber (16.30−15.92=0.38 dB) confirms that the inscribed FBGs were sufficiently stabilized by the annealing treatment obtained through the use of the system 500 in FIG. 5 with the parameters of this example.

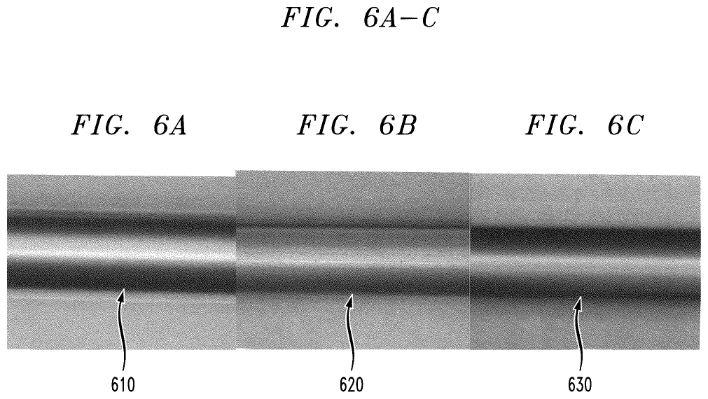

In this example, the coating degradation was measured after the two different anneals. The degradation is evident in a discoloration of the coating in a microscopic image discussed below. The more yellow the coating appearance, the more the coating has degraded from its initial state which is clear in the visible spectrum. FIGS. 6A-C depict the following coating images: (FIG. 6A) after annealing in the system 500 of FIG. 5 with parameters of the third example (Annealed 450° C., line speed=10 meters per minute); (FIG. 6B) after annealing in the system 500 of FIG. 5 with parameters of the third example (Annealed 450° C., line speed=10 meters per minute) followed by an anneal at 160° C. for 89 hours; (FIG. 6C) the same fiber with only the annealing at 160° C. for 89 hours. FIG. 6A shows that the coating shows minimal degradation after the anneal in the system 500 of FIG. 5. While FIGS. 6B and 6C show that the coating has significant degradation after annealing at 160° C. for 89 hours.

The present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An optical fiber, comprising:
a fiber length;
a coating having a treated coating weight, wherein the treated coating weight is at least 25% less of an original coating weight prior to an annealing treatment; and
an optical back-scatter along the fiber length greater than a Rayleigh back-scattering over the fiber length, wherein the optical back-scatter does not decrease along the fiber length by more than 3 dB after the annealing treatment.

2. The optical fiber of claim 1, wherein the optical back-scatter for core-guided modes of the optical fiber was at least 25 dB greater than Rayleigh back-scattering prior to the annealing treatment and reflectivity enhancements measured after the annealing was at least 15 dB.

3. The optical fiber of claim 1, wherein one or both of the coating and the optical fiber exhibits an outgassing of hydrogen molecules following the annealing treatment.

4. The optical fiber of claim 1, wherein the coating is transparent at a wavelength of actinic radiation used to apply the optical back-scatter.

5. The optical fiber of claim 1, wherein the coating includes one or more of the following components: acrylates, silicones, polyimides, carbon, ceramics, and metals.

6. The optical fiber of claim 1, wherein the coating is fully cured and the optical back-scatter is stabilized following thermal curing.

7. A method, comprising:
receiving an optical fiber at an inlet of at least one heat source, the optical fiber including a coating having an original coating weight and an optical back-scatter along a fiber length; and
applying an annealing treatment to the optical fiber by the least one heat source at a predetermined temperature T a during a predetermined time tₐ,
wherein the original coating weight is reduced by at least 25% to a treated coating weight during the annealing treatment,
wherein the optical back-scatter does not decrease along the fiber length by more than 3 dB after the annealing treatment.

8. The method of claim 7, further comprising:
using a cooling system to restore and reharden the coating after the annealing treatment.

9. The method of claim 7, wherein the coating is applied to the optical fiber by actinic radiation prior to annealing treatment.

10. The method of claim 7, wherein the optical back-scatter is inscribed on the optical fiber prior to annealing treatment.

11. The method of claim 7, wherein the least one heat source includes a plurality of furnaces using a variety of predetermined temperatures Tₐ and predetermined durations tₐ.

12. The method of claim 7, wherein one or both of the coating and the optical fiber exhibits an outgassing of hydrogen molecules following the annealing treatment.

13. The method of claim 7, wherein the least one heat source is a tube furnace having an inlet and an outlet, such that hydrogen is outgassed via the inlet and outlet of the tube furnace.

14. The method of claim 7, wherein the optical back-scatter for core-guided modes of the optical fiber was at least 25 dB greater than Rayleigh back-scattering prior to the annealing treatment and reflectivity enhancements measured after the annealing was at least 15 dB.

15. The method of claim 7, wherein the coating is transparent at a wavelength of actinic radiation used to apply the optical back-scatter.

16. The method of claim 7, wherein the coating includes one or more of the following components: acrylates, silicones, polyimides, carbon, ceramics, and metals.

17. The method of claim 7, wherein the coating is fully cured and the optical back-scatter is stabilized following thermal curing.

18. The method of claim 17, wherein the thermal curing is performed by one of a UV curing lamp, a lower temperature furnace, a fiber cooling device, a system to flow restorative gasses on the fiber coating, or any combination thereof.
